(19) United States
(12) Patent Application Publication
(10) Pub. No.: US 2010/0224680 A1
(43) Pub. Date: Sep. 9, 2010

(54) Web of safety

(76) Inventor: Rosette Marturana, Mt. Prospect, IL (US)

Correspondence Address: Rosette Marturana, 1401 N. Sauk Ln., Mt. Prospect, IL, 60056, US

(21) Appl. No.: 12/380,666

(22) Filed: Mar. 3, 2009

(51) Int. Cl. G06F 19/00

(52) U.S. Cl. 235/380

(57) ABSTRACT

A method of locating people by using radio frequency identification (RFID) and/or global positioning system (GPS) that is imbedded in a gift card and/or keytag which holds digital information in a microchip which communicates through a data base assigned for this use to locate missing or lost people when activated. There also may be chipless form of RFID and/or GPS that use a material to reflect back a signal of the radio waves beamed at them in return identifying the location of the card/keytag holder. The gift card/keytag may also have a barcode and/or assigned number for identifying purposes. Gift card/keytag will be sold at retail establishments and on line. Gift card/keytag is a four part card assembly that has a RFID and/or GPS microchip imbedded in card, barcode, individually numbered, keytag, aperture. There will be a website to register card with customers personal information. This device may also be put in vehicles and activated if the missing person is missing with their car.

### BRIEF DESCRIPTION OF DRAWINGS

Located on Front of Card:

FIG. 1:

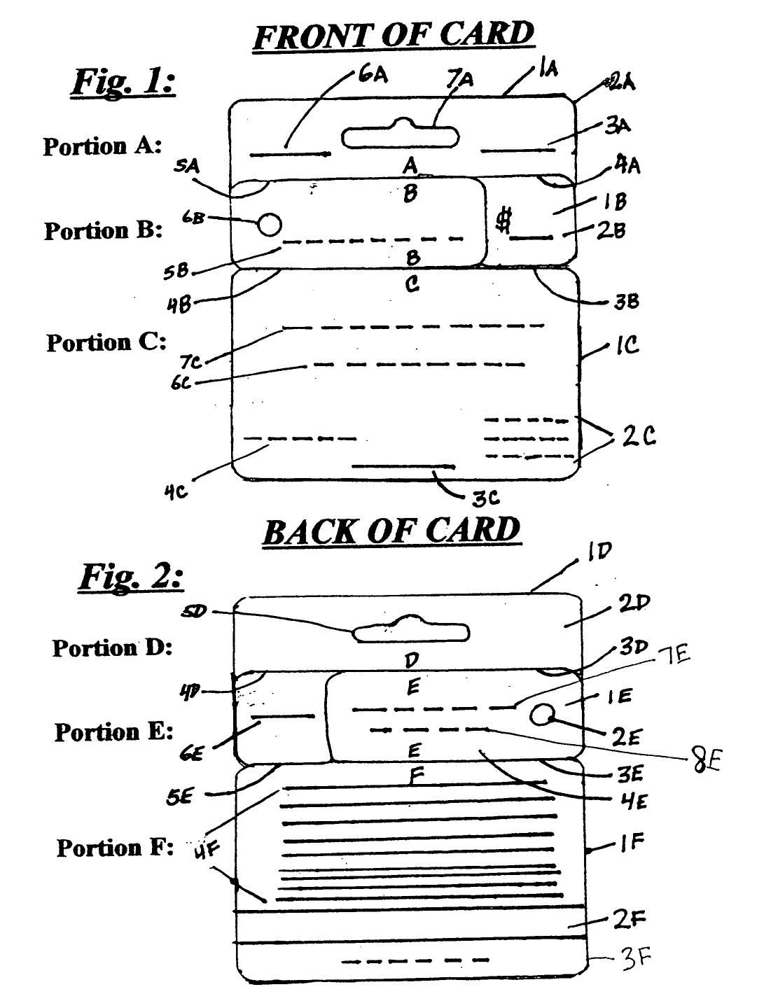

Portion A:

1A: Card packaging assembly, made from a single plastic sheet.

Dimensions: L-3¼×W-30 mil.×H-3¾

Include perforated lines with a weakened scored portion

2A: Top portion of assembly, that includes the aperture include perforated lines with a weakened scored portion. Separating from Portion A from Portion B.

Dimensions: L-3¼×W-30 mil.×H ¾

3A: Barcode for Sale Purposes at Retail Establishments and on line sales.

4A: Display portion with Perforated lines with a weakened scored portion for customer removal separating Portion A from Portion

5A: Display portion with Perforated lines with a weakened scored portion for customer removal separating Portion A from Portion B.

6A: Logo/Trademark/Campaign/Slogan space. To be determined.

7A: Geometric Aperture for card display from a peg, etc. All though the aperture is shown in the invention one way it is not so limited.

Portion B:

1B: Middle Portion of assembly, that include perforated lines with a weakened scored

Portion. Separating from portions A and B. Also separating key tag and monetary money Portion.

Dimension: L-3¼×W-30 mil.×H-⅞

2B: Specific monetary cost of Gift Card. This Portion is to be Removed and Recycled.

Dimension: L-⅞×W-30 mil.×H-⅞

3B: Display portion with Perforated lines with a weakened scored portion for customer removal from portion B from Portion C.

4B: Display portion with Perforated lines with a weakened scored portion for customer removal from Portion B from Portion C.

5B: Keytag apparatus with the Web of Safety.com Logo/website address. All through the drawings is shown one way, but it is not so limited to.

Dimension: L-⅞×W-30 mil×H-2⅜

6B: Keytag hole for customer to attachment to keychain, and such.

Portion C:

1C: Front side of Web of Safety gift card.

Dimension: L-3¼×W-30 mil.×H-2⅛

2C: Information on how to use this service and how to have this product activated through the date base provided for this service and/or contact authorities to activate this device in an emergency circumstance.

3C: Environmentally friendly re-usable statement.

4C: Location designated to Sponsors.

6C: Web of Safety contact information for emergency purpose for activation of this emergency device.

7C: Logo/Web address: Web of Safety.com.

Located on the Back of Card:

FIG. 2:

Portion D:

1D: Card packaging assembly, made from a single plastic sheet.

Dimensions: L-3¼×W-30 mil.×H-3¾

Include perforated lines with a weakened scored portion

2D: Top portion of assembly, that includes the aperture that for displaying Gift Card from a hook or such. Include perforated lines with a weakened scored portion.

Dimensions: L-3¼×W-30 mil.×H ¾

3D: Perforated line with a weakened scored portion Separating from Portion D from Portion E.

4D: Perforated line with a weakened scored portion Separating from Portion D from Portion E.

5D: Geometric Aperture for card display from a peg, etc. All though the aperture is shown in the invention one way it is not so limited.

Portion E:

1E: Middle portion of assembly, that include perforated lines with a weakened scored portion.

Separating from Portions E and F. Also separating keytag and monetary money portion.

Dimension: L-3¼×W-30 mil.×H-⅞

2E: Keytag hole for customer to attach to keychain.

3E: Perforated line with a weakened scored portion Separating from Portion E from Portion F.

4E: Keytag apparatus with Web of Safety.com contact information for emergency purpose for activation of this emergency device.

Dimension: L-⅞×W-30 mil×H-2⅜

5E: Perforated line with a weakened scored portion Separating from Portion E from Portion F.

6E: This portion is to be removed and recycled.

7E: The RFID (Radio Frequency Identification) and/or GPS (Global Positioning Service) device is imbedded in gift card.

8F: Each keytag will be assigned it's own individual number, providing information for that gift card only. For identifying purposes.

Dimension: L-⅞×W-30 mil.×H-⅞

Portion F:

1F: Back side of the Web of Safety:

Dimension: L-3¼×W-30 mil.×H-2⅛

2F: The RFID (Radio Frequency Identification) and/or GPS (Global Positioning Service) device is imbedded in gift card.

3F: Each gift card will be assigned it's own individual number, providing information for that gift card only. For identifying purposes.

4F: Disclaimer and description of uses and terms and conditions of Gift Card.

Although this invention is shown one way it is not so limited.

1. A method of using a gift card for the purpose of safety for the public by using as a tracking device for missing people. Radio Frequency Identification (RFID) and/or Global Positioning System (GPS) microchip and/or chipless form of RFID imbedded in the card. By keeping this gift card/keytag on the person or person's belongings to be activated when the person can not be located, missing or lost. For emergency purposes to locate lost or missing people through data base of proper authorities. This device may also be put in vehicles and activated if the missing person is missing with their car.
